(19) United States
(12) Patent Application Publication
(10) Pub. No.: US 2023/0229896 A1
(43) Pub. Date: Jul. 20, 2023

(54) METHOD AND COMPUTING DEVICE FOR DETERMINING OPTIMAL PARAMETER

(71) Applicant: NOTA, INC., Daejeon (KR)

(72) Inventors: Tae-Ho KIM, Seoul (KR); Myungsu CHAE, Gwangmyeong-si (KR); Jongwon BAEK, Uiwang-si (KR); Dongwook KIM, Seoul (KR); Dong Uk LIM, Seoul (KR); Cheol-Bin PARK, Seoul (KR); Bibek CHAUDHARY, Seoul (KR)

(21) Appl. No.: 18/188,392

(22) Filed: Mar. 22, 2023

Related U.S. Application Data
(63) Continuation-in-part of application No. PCT/KR2021/017320, filed on Nov. 23, 2021.

(30) Foreign Application Priority Data
Jan. 29, 2021 (KR) 10-2021-0013311

(51) Int. Cl. G06N 3/0495

(52) U.S. Cl. CPC G06N 3/0495

(57) ABSTRACT

Provided are a method and computing device for determining an optimal parameter set. The method includes receiving an inference model, a dataset, and a constraint, configuring a set of compression methods and a set of parameters, applying a first compression method and a first parameter related to the first compression method to the inference model through a compression pipeline, determining whether a compressed inference model is generated from the inference model through the compression pipeline, when it is determined that the compressed inference model is not generated, applying a second compression method, and a second parameter to the inference model, following the first compression method, when it is determined that the compressed inference model is generated, transmitting the compressed inference model to the target device, and determining an optimal set of parameters on the basis of the performance of the compressed inference model received from the target device.

### CROSS-REFERENCE TO RELATED APPLICATION(S)

This application is a bypass continuation-in-part of International Application No. PCT/KR2021/017320, filed on Nov. 23, 2021, which is based on and claims priority to Korean Patent Application No. 10-2021-0013311, filed on Jan. 29, 2021, in the Korean Intellectual Property Office, the disclosure of which are incorporated by reference herein in their entireties.

### BACKGROUND

### 1. Field of the Invention

The present disclosure relates to a method and system for compressing an artificial intelligence inference model, and more particularly, to a method and system for determining an optimal parameter set for compressing an inference model.

### 2. Discussion of Related Art

Compressing a deep learning model (or an artificial intelligence model) is a function, a module, and/or a function of shrinking a given deep learning model into a smaller deep learning model. Here, “shrinking” may mean reducing the number of weights or biases constituting the deep learning model, reducing the capacity, or increasing the inference speed. In a compressing process, it is very important not to degrade the performance.

There are various types of compressing techniques. Compressing techniques are roughly classified into pruning, quantization, knowledge distillation, neural architecture search, and filter decomposition, and each classification includes various kinds of compressing techniques.

Each compressing technique cannot be simply used. There are parameters for using each compressing technique. For example, in the case of pruning, a parameter for determining how many parameters will be pruned should be adjusted per layer in advance, and compressing performance is much affected by a setting of the parameter.

### SUMMARY OF THE INVENTION

The summary of specific exemplary embodiments disclosed herein will be proposed below. Aspects proposed in the following summary are only for the purpose of providing the simple summary of the specific exemplary embodiments and should be understood as not limiting the scope of the present disclosure. Therefore, the present disclosure may include various aspects that are not proposed below.

The present disclosure is directed to providing a method and system for compressing a deep learning model by applying various compressing techniques to a deep learning model in sequence or parallel.

The present disclosure is also directed to providing an optimal parameter set for compressing a deep learning model on the basis of a deep learning model, a dataset, and a constraint input by a user.

According to an aspect of the present disclosure, there is provided a method of determining an optimal parameter set that is performed by a computing device including at least one processor, the method comprising: receiving an inference model, a dataset, and a constraint, configuring a set of compression methods to be applied to the inference model and a set of parameters for the set of compression methods on the basis of the constraint, applying a first compression method included in the set of compression methods and a first parameter related to the first compression method to the inference model, through a compression pipeline, determining whether a compressed inference model is generated from the inference model through the compression pipeline, when it is determined that the compressed inference model is not generated, applying a second compression method included in the set of compression methods, and a second parameter among the set of parameters to the inference model, following the first compression method, through the compression pipeline, when it is determined that the compressed inference model is generated, transmitting the compressed inference model to the target device, and determining an optimal set of parameters on the basis of the performance of the compressed inference model received from the target device, wherein the performance of the compressed inference model is measured by the target device using the dataset.

The configuring the set of compression methods and the set of parameters may include: selecting the first compression method and the first parameter for the first compression method, determining whether to further select a compression method and a parameter on the basis of the constraint and the first compression method, and when it is determined to further select a compression method and a parameter, selecting the second compression method and the second parameter for the second compression method on the basis of the first compression method.

When the performance of the compressed inference model satisfies the constraint, the selected set of parameters may be determined as the optimal parameter set, and wherein when the performance of the compressed inference model does not satisfy the constraint, the configuring the set of compression methods and the set of parameters, the applying the first compression method and the first parameter to the inference model, the determining whether the compressed inference model is generated, the applying the second compression method and the second parameter to the inference model, the transmitting the compressed inference model to the target device, and the determining the optimal parameter set may be repeatedly performed.

The constraint may include a value of at least one item among device, accuracy, model size, latency, compression time, and energy consumption.

A priority may be assigned to each of a plurality of items included in the constraint. The determining the optimal set of parameters may include: determining whether the compressed inference model satisfies the constraint based on the priority at least a predetermined criterion on the basis of the performance of the compressed inference model.

The set of compression methods may be selected from a compression method pool. The compression method pool may include pruning, quantization, resolution change, and filter decomposition.

The performance of the compressed inference model may include a value of at least one item among latency, accuracy, and energy consumption.

The set of compression methods may be configured on the basis of a predetermined rule. The predetermined rule may include at least one of a first rule that a quantization-based compression method included in the optimal parameter set is to be positioned last in the compression pipeline or a second rule that an activation change-based compression method is to be positioned before the quantization-based compression method.

According to an aspect of the present disclosure, there is provided a computing device for determining an optimal parameter set, the computing device comprising: a memory configured to store at least one instruction, and at least one processor executing the at least one instruction, wherein the processor is configured to: receive an inference model, a dataset, and a constraint, configure a set of compression methods to be applied to the inference model and a set of parameters for the set of compression methods on the basis of the constraint, apply a first compression method included in the set of compression methods and a first parameter related to the first compression method to the inference model, through a compression pipeline, determine whether a compressed inference model is generated from the inference model through the compression pipeline, when it is determined that the compressed inference model is not generated, apply a second compression method included in the set of compression methods, and a second parameter among the set of parameters to the inference model, following the first compression method, through the compression pipeline, when it is determined that the compressed inference model is generated, transmit the compressed inference model to the target device, and determine an optimal set of parameters on the basis of the performance of the compressed inference model received from the target device, wherein the performance of the compressed inference model is measured by the target device using the dataset.

The processor may be further configured to: select the first compression method and the first parameter for the first compression method, determine whether to further select a compression method and a parameter on the basis of the constraint and the first compression method, and when it is determined to further select a compression method and a parameter, select the second compression method and the second parameter for the second compression method on the basis of the first compression method.

When the performance of the compressed inference model satisfies the constraint, the selected set of parameters may be determined as the optimal parameter set. When the performance of the compressed inference model does not satisfy the constraint, the processor may be further configured to: repeatedly configure the set of compression methods and the set of parameters, apply the first compression method and the first parameter to the inference model, determine whether the compressed inference model is generated, apply the second compression method and the second parameter to the inference model, transmit the compressed inference model to the target device, and determine the optimal parameter set.

A priority may be assigned to each of a plurality of items included in the constraint. The processor may be further configured to determine whether the compressed inference model satisfies the constraint based on the priority at least a predetermined criterion on the basis of the performance of the compressed inference model.

The processor may be further configured to select the set of compression methods from a compression method pool, and wherein the compression method pool may include pruning, quantization, resolution change, and filter decomposition.

The processor may be further configured to configure the set of compression methods on the basis of a predetermined rule. The predetermined rule may include at least one of a first rule that a quantization-based compression method included in the optimal parameter set is to be positioned last in the compression pipeline or a second rule that an activation change-based compression method is to be positioned before the quantization-based compression method.

According to an aspect of the present disclosure, there is provided a method of determining an optimal parameter that is performed by a computing device including at least one processor, the method comprising: receiving an inference model, a dataset, and a constraint, selecting a plurality of first compression methods to be applied to the inference model and a plurality of first parameters, each of the plurality of first parameters being associated with a respective one of the plurality of first compression methods, receiving, from a target device selected on the basis of the constraint, performance of a plurality of first compressed models obtained by applying the plurality of first compression methods and the plurality of first parameters to the inference model and selecting one of the plurality of first compressed models on the basis of the performance of the plurality of first compressed models, determining whether to additionally compress the selected first compressed model on the basis of the constraint, and when it is determined to additionally compress the selected first compressed model, selecting a plurality of second compression methods to be applied to the selected first compressed model and a plurality of second parameters, each of the plurality of second parameters being associated with a respective one of the plurality of second compression methods, wherein the performance of the plurality of first compressed models is measured by the target device using the dataset.

The method may further include receiving, from the target device, performance of a plurality of second compressed models obtained by applying the plurality of second compression methods and the plurality of second parameters to the selected first compressed model and selecting one of the plurality of second compressed models on the basis of the performance of the plurality of second compressed models, determining whether to additionally compress the selected second compressed model on the basis of the constraint, and when it is determined not to additionally compress the selected second compressed model, selecting the first compression method, the first parameter, the second compression method and the second parameter used for generating the selected second compressed model as an optimal parameter set.

The plurality of first compressed models may be trained on the basis of the dataset, and a number of training times of the plurality of first compressed models may be determined on the basis of the constraint on compression time.

The determining of whether to additionally compress the selected first compressed model may be on the basis of a preset number of times or whether performance of the selected first compressed model satisfies a preset constraint.

According to another aspect of the present disclosure, there is provided a computer-readable recording medium on which a program for causing a computing device to perform the method is recorded.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other objects, features, and advantages of certain embodiments of the disclosure will be more apparent from the following description taken in conjunction with the accompanying drawings, in which:

FIG. 1 is a diagram illustrating an example of a network environment according to an exemplary embodiment of the present disclosure;

FIG. 2 is a block diagram illustrating an example of a computing device according to an exemplary embodiment of the present disclosure;

FIG. 3 is a diagram illustrating an example of a compressing system according to an exemplary embodiment of the present disclosure;

FIG. 4 is a flowchart illustrating an example of a compressing method according to an exemplary embodiment of the present disclosure;

FIG. 5 is a diagram illustrating an example of an optimal parameter determination process according to an exemplary embodiment of the present disclosure;

FIG. 6 is a block diagram illustrating an example of an internal configuration of hyperparameter optimization (HPO) according to an exemplary embodiment of the present disclosure;

FIG. 7 is a flowchart illustrating an example of a method of determining an optimal parameter by HPO according to an exemplary embodiment of the present disclosure;

FIG. 8 is a block diagram illustrating an example of an internal configuration of a target device according to an exemplary embodiment of the present disclosure;

FIG. 9 is a flowchart illustrating an example of a method of determining an optimal parameter by a target device according to an exemplary embodiment of the present disclosure;

FIG. 10 is a diagram illustrating a method of determining an optimal parameter according to an exemplary embodiment of the present disclosure; and

FIG. 11 is a diagram illustrating a method of determining an optimal parameter according to another exemplary embodiment of the present disclosure.

### DETAILED DESCRIPTION OF EXEMPLARY EMBODIMENTS

Terminology used in the present specification will be briefly described first, and then the present disclosure will be described in detail.

As terms used herein, general terms currently used as widely as possible will be selected in consideration of functionality in the present disclosure, but may vary depending on intent of those of ordinary skill in the art, precedents, the advent of new technology, etc. In particular, a term may be arbitrarily selected by the applicant. In this case, the meaning of the term will be explained in detail through the relevant descriptions. Therefore, the terms used herein should be defined on the basis of their meanings and the overall content of the present disclosure rather than their names.

The present disclosure can be modified in various ways and have a variety of embodiments, and thus specific embodiments will be illustrated in the drawings and described in detail. However, it is to be understood that the specific embodiments are not intended to limit the present disclosure and the embodiments may include all modifications, equivalents, and substitutions that are included in the spirit and technical scope of the present disclosure. In describing the embodiments, when it is determined that detailed description of a relevant known technology may obscure the gist of the present disclosure, the detailed description will be omitted.

Terms such as first, second, etc. may be used in describing various components, but the components should not be limited by the terms. The terms are used only for the purpose of distinguishing one component from other components.

Singular expressions include plural expressions unless the context clearly indicates otherwise. In the present application, terms such as “include,” “have,” etc. are intended to indicate the existence of a feature, a number, a step, an operation, a component, a part, or a combination thereof described herein, and it should be understood that the existence of one or more other features, numbers, steps, operations, components, parts, or combinations thereof is not excluded in advance.

Hereinafter, exemplary embodiments of the present disclosure will be described with reference to the accompanying drawings so that those of ordinary skill in the art can readily implement the present disclosure. However, the present disclosure may be implemented in various different forms and is not limited to the embodiments set forth herein. To clearly describe the present disclosure, parts unrelated to the description will be omitted in the drawings. Throughout the specification, like reference numbers refer to like elements.

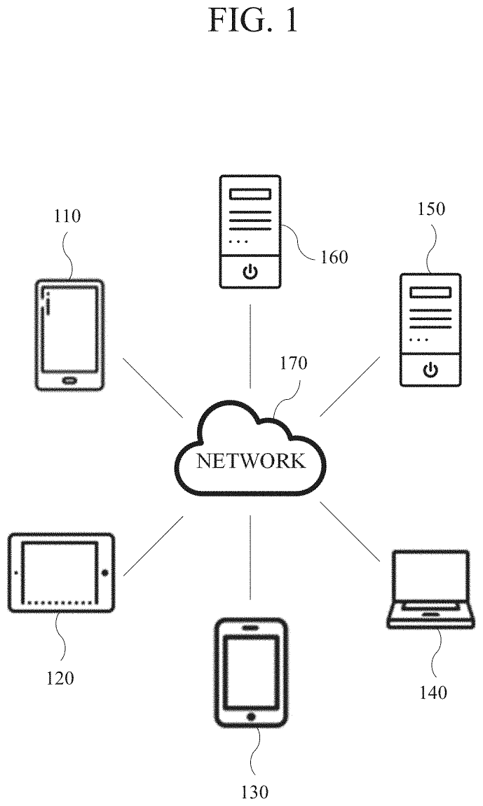

FIG. 1 is a diagram illustrating an example of a network environment according to an exemplary embodiment of the present disclosure.

Referring to FIG. 1, the network environment may include a plurality of electronic devices 110, 120, 130, and 140, a plurality of servers 150 and 160, and a network 170. FIG. 1 is an example illustrating the present disclosure, and the number of electronic devices or the number of servers is not limited to that shown in FIG. 1. Also, the network environment of FIG. 1 merely illustrates an example of environments that are applicable to exemplary embodiments, and environments applicable to exemplary embodiments are not limited to the network environment of FIG. 1.

The plurality of electronic devices 110, 120, 130, and 140 may be fixed terminals or mobile terminals that are implemented as computing devices. Examples of the plurality of electronic devices 110, 120, 130, and 140 may be a smartphone, a cellular phone, a navigation device, a computer, a laptop computer, a digital broadcast terminal, a personal digital assistant (PDA), a portable multimedia player (PMP), a tablet personal computer (PC), etc. As an example, FIG. 1 shows the shape of a smartphone as an example of the electronic device 110, but in exemplary embodiments of the present disclosure, the electronic device 110 may be one of various physical computing devices that may substantially communicate with the other electronic devices 120, 130, and 140 and/or the servers 150 and 160 through the network 170 using a wireless or wired communication method.

There are no limitations on the communication method, which may not only be a communication method employing a communication network (e.g., a mobile communication network, wired Internet, wireless Internet, or a broadcast network) that may be included in the network 170 but may also be a short-range wireless communication method between devices. For example, the network 170 may include at least one of a personal area network (PAN), a local area network (LAN), a campus area network (CAN), a metropolitan area network (MAN), a wide area network (WAN), a broadband network (BBN), the Internet, etc. Also, the network 170 may include at least one of network topologies including a bus network, a start network, a ring network, a mesh network, a star-bus network, a tree or hierarchical network, etc., but is not limited thereto.

Each of the servers 150 and 160 may be implemented as a computing device or a plurality of computing devices that provide instructions, code, files, content, services, etc. by communicating with the plurality of electronic devices 110, 120, 130, and 140 through the network 170. For example, the server 150 may be a system that provides a service (e.g., an instant messaging service, a social networking service, a payment service, a virtual exchange service, a risk monitoring service, a game service, a group call service (or a voice conference service), a messaging service, a mail service, a map service, a translation service, a financial service, a search service, a content provision service, etc.) to the plurality of electronic devices 110, 120, 130, and 140 that access the server 150 through the network 170.

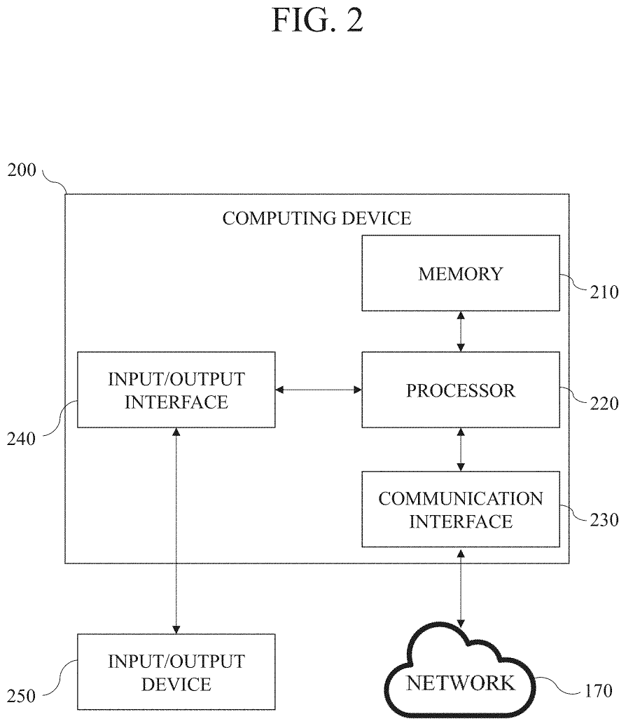

FIG. 2 is a block diagram illustrating an example of a computing device according to an exemplary embodiment of the present disclosure.

Referring to FIG. 2, each of the plurality of electronic devices 110, 120, 130, and 140 or the servers 150 and 160 described above may be implemented by a computing device 200.

As shown in FIG. 2, the computing device 200 may include a memory 210, a processor 220, a communication interface 230, and an input/output interface 240. The memory 210 is a computer-readable recording medium and may include a random access memory (RAM) and permanent mass storage devices such as a read only memory (ROM) and a disk drive. The permanent mass storage devices, such as a ROM and a disk drive, may be included in the computing device 200 as a separate permanent storage device distinguished from the memory 210. Also, the memory 210 may store an operating system and at least one piece of program code. Such software components may be loaded from a computer-readable recording medium which is separate from the memory 210 into the memory 210. The separate computer-readable recording medium may be a floppy drive, a disk, a tape, a digital versatile disc (DVD)/compact disc ROM (CD-ROM) drive, a memory card, etc. According to another exemplary embodiment, the software components may be loaded into the memory 210 not from a computer-readable recording medium but through the communication interface 230. For example, the software components may be loaded into the memory 210 of the computing device 200 on the basis of a computer program installed with files received through the network 170.

The processor 220 may be configured to process instructions of a computer program by performing fundamental arithmetic, logic, and input/output operations. The instructions may be provided to the processor 220 by the memory 210 or the communication interface 230. For example, the processor 220 may be configured to execute an instruction received in accordance with program code stored in a storage device such as the memory 210.

The processor 220 may be electrically connected to the memory 210 to control overall functions and operations of the computing device 200. The processor 220 may control the computing device 200 by executing instructions stored in the memory 210.

The processor 220 may receive an inference model, a dataset, and a constraint from a user. The constraint may include a value of at least one item among device, accuracy, model size, latency, compression time, and energy consumption.

The processor 220 may select a plurality of first compression methods and a plurality of first parameters. Each of the plurality of first parameters may be associated with a respective one of the plurality of first compression methods. For example, the plurality of first compression methods may include pruning and the plurality of first parameters may include a pruning ratio (PR) which is a compression parameter corresponding to pruning. As another example, the plurality of first compression methods may include filter decomposition and the plurality of first parameters may include a parameter corresponding to the filter decomposition.

The processor 220 may generate a plurality of first compressed models by compressing the inference model using the plurality of first compression methods and the plurality of first parameters. The processor 220 may select a target device from a target device pool on the basis of the constraint input by the user. The processor 220 may control the communication interface 230 to transmit the plurality of first compressed models to the selected target device. The selected target device may execute each of the plurality of first compressed models to measure performance of each of the plurality of first compressed models.

The processor 220 may receive the performance of the plurality of first compressed models from the target device through the communication interface 230. The processor 220 may select one of the plurality of first compressed models on the basis of the received performance and the constraint input by the user. For example, the processor 220 may select a first compressed model having the shortest latency. Alternatively, the processor 220 may select a first compressed model having the highest accuracy. Meanwhile, the performance of the plurality of first compressed models may be evaluated on the basis of not only a single item (e.g., latency) that may reflect performance but also a plurality of items (e.g., a combination of latency and accuracy). Here, weights may be applied to the plurality of items in a predetermined order of priority, and then the products may be added to calculate final performance. Meanwhile, the processor 220 may select two or more of the plurality of first compressed models. For example, the processor 220 may select a predetermined number of first compressed models in descending order of performance.

The processor 220 may determine whether to additionally compress the selected first compressed model on the basis of the constraint. For example, the processor 220 may make the judgment on the basis of a preset number of times or whether the performance of the selected first compressed model satisfies the preset constraint.

In the case of additionally compressing the selected first compressed model, the processor 220 may select a plurality of second compression methods and a plurality of second parameters. Each of the plurality of second parameters may be associated with a respective one of the plurality of second compression methods. The processor 220 may generate a plurality of second compressed models by compressing the selected first compressed model using the plurality of second compression methods the plurality of second parameters. The processor 220 may receive performance of the plurality of second compressed models from the target device. The processor 220 may select one of the plurality of second compressed models on the basis of the performance of the plurality of second compressed models. The processor 220 may determine whether to additionally compress the selected second compressed model on the basis of the constraint.

In the case of not additionally compressing the selected second compressed model (e.g., when it is determined that the selected second compressed model does not satisfy the constraint after additional compression), the processor 220 may determine the first compression method, the first parameter, the second compression method and the second parameter used for generating the selected second compressed model as an optimal parameter set. In the case of additionally compressing the selected second compressed model (e.g., when it is determined that the selected second compressed model satisfies the constraint even after additional compression), the processor 220 may select a plurality of third parameters to be applied to the selected second compressed model. Then, the processor 220 may compress the selected second compressed model.

When the optimal parameter set is determined, the processor 220 may generate a compression pipeline using the optimal parameter set. The processor 220 may sequentially arrange parameters each corresponding to the compression steps in the compression pipeline.

The processor 220 may configure a set of compression methods to be applied to the inference model and a set of parameters for the set of compression methods on the basis of the constraint. The set of compression methods may include a sequence of compression methods

The processor 220 may select the first compression method and the first parameter for the first compression method.

The processor 220 may determine whether to further select a compression method and a parameter on the basis of the constraint and the first compression method.

When it is determined to further select a compression method and a parameter, the processor 220 may select the second compression method and the second parameter for the second compression method on the basis of the first compression method.

The processor 220 may apply a first compression method included in the set of compression methods and a first parameter related to the first compression method to the inference model, through a compression pipeline.

The processor 220 may determine whether a compressed inference model is generated from the inference model through the compression pipeline.

When it is determined that the compressed inference model is not generated, the processor 220 may apply a second compression method included in the set of compression methods, and a second parameter among the set of parameters to the inference model, following the first compression method, through the compression pipeline.

When it is determined that the compressed inference model is generated, the processor 220 may transmit the compressed inference model to the target device.

The processor 220 may determine an optimal set of parameters on the basis of the performance of the compressed inference model received from the target device.

When the performance of the compressed inference model satisfies the constraint, the processor 220 may determine the selected set of parameters as the optimal parameter set.

When the performance of the compressed inference model does not satisfy the constraint, the processor 220 may repeatedly perform the operation of the configuring the set of compression methods and the set of parameters, the operation of the applying the first compression method and the first parameter to the inference model, the operation of the determining whether the compressed inference model is generated, the operation of the applying the second compression method and the second parameter to the inference model, the operation of the transmitting the compressed inference model to the target device, and the operation of the determining the optimal parameter set.

The communication interface 230 may provide a function for the computing device 200 to communicate with other devices (e.g., the foregoing storage devices) through the network 170. For example, a request, an instruction, data, a file, etc. generated by the processor 220 of the computing device 200 in accordance with program code stored in a storage device, such as the memory 210, may be transmitted to other devices through the network 170 under the control of the communication interface 230. In reverse, a signal, an instruction, data, a file, etc. of another device may be passed through the network 170 and received by the computing device 200 through the communication interface 230 of the computing device 200. A signal, an instruction, data, etc. received through the communication interface 230 may be transmitted to the processor 220 or the memory 210, and a file and the like may be stored in a storage medium (the foregoing permanent storage device) that may be further included in the computing device 200.

The input/output interface 240 may be a device for interfacing with input/output devices 250. As an example, input devices may include a microphone, a keyboard, a mouse, etc., and output devices may include a display, a speaker, etc. As another example, the input/output interface 240 may be a device for interfacing with a device having one integrated function for input and output such as a touchscreen. At least one of the input/output devices 250 may be integrated with the computing device 100. For example, as in a smartphone, a touch screen, a microphone, a speaker, etc. may be included in the computing device 200.

According to other embodiments, the computing device 200 may include a larger or smaller number of components than those of FIG. 2. However, it is unnecessary to clearly show most components of the related art. For example, the computing device 200 may include at least some of the input/output devices 250 or additionally include other components such as a transceiver, a database, etc.

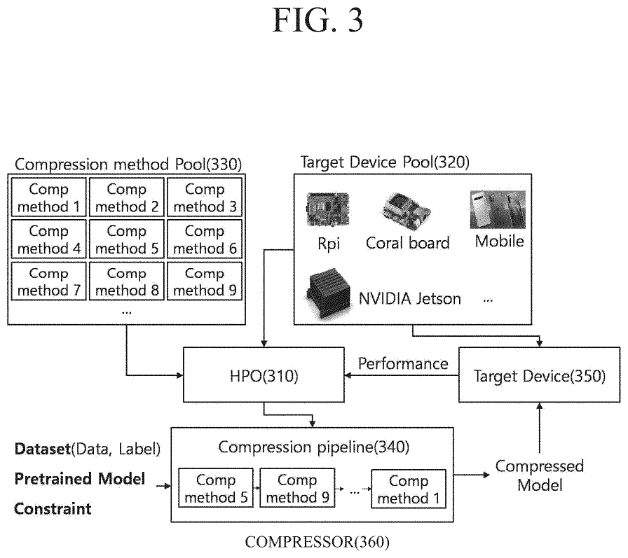

FIG. 3 is a diagram illustrating an example of a compressing system according to an exemplary embodiment of the present disclosure.

Referring to FIG. 3, a compressing system 300 according to an exemplary embodiment may include hyperparameter optimization (HPO) 310, a target device pool 320, a compression method pool 330, a compression pipeline 340, and a compressor 360.

Compressing techniques heavily depend on parameters. Accordingly, when multiple compressing techniques are used, performance may be greatly affected by how parameters of each compressing technique are set. To solve this problem, the compressing system 300 may include the HPO 310 and the target device pool 320.

The HPO 310 may be an algorithm for finding an optimal hyperparameter in a given hyperparameter search space and may substantially be an expression of a function of the processor 220 of the computing device 200 which implements the compressing system 300, operating in accordance with the control of a computer program. For example, the HPO 310 may learn each of set of parameters 1, set of parameters 2, . . . , and set of parameters N among possible set of parameters. After that, the HPO 310 may discard some of the set of parameters having low performance and search for a new set of parameters on the basis of high-ranking set of parameters having high performance. Examples of hyperparameters include batch size, learning rate, momentum, etc. When categories of hyperparameters are set to the number of layers, the number of neurons, and a type of layer, the HPO 310 may include neural architecture search (NAS). Meanwhile, in the present disclosure, a set of parameters may also be referred to as a set of parameters.

The HPO 310 according to the present exemplary embodiment may process a search of a distinctive search space. Parameters of multiple compressing techniques may be a search space. For example, PRs, quantization thresholds, temperatures in knowledge distillation (KD), etc. may be a search space of the HPO 310. The HPO 310 may employ an algorithm such as Hyperband or Bayesian Optimization.

Meanwhile, the target device pool 320 and the compression method pool 330 may be implemented in the form of, for example, a database. The target device pool 320 may include information on various devices, and the compression method pool 330 may include code for each of various compression methods. The HPO 310 may select a compression method from the compression method pool 330 and compress an inference model using the selected compression method. Already known devices and compression methods may be used as the devices included in the target device pool 320 and the compression methods included in the target device pool 320.

In compressing of an inference model, the HPO 310 may select two or more compression methods from the compression method pool 330 and sequentially arrange the selected two or more compression methods in the compression pipeline 340. Subsequently, the HPO 310 may input the inference model to the compression pipeline 340 to process compressing of the inference model so that the inference model is sequentially compressed with the two or more compression methods. According to an exemplary embodiment, the compression pipeline 340 may be implemented to be included in the HPO 310.

The compressor 360 may generate a compressed model using each of various combinations of compression methods. According to an exemplary embodiment, the compressor 360 may run multiple compression pipelines and generate multiple compressed models in parallel by applying different combinations of compression methods to one inference model. For example, when there are multiple target devices, the compressor 360 may simultaneously generate multiple compressed models for the multiple target devices by running multiple compression pipelines.

The compressed model may be transmitted from the target device pool 320 to a selected target device 350. The target device 350 may measure performance, such as latency, accuracy, etc., by executing code of the compressed inference model (shortly referred to as compressed model) and then return the measured performance to the HPO 310. The HPO 310 may make a discrimination between set of parameters on the basis of the returned performance and can find an optimized set of parameters for the target device 350 in accordance with such superiority and inferiority.

For this process, for example, an inference model, a dataset (including data and a label), and a constraint may be input to the HPO 310. Here, the constraint may include a value of at least one item among device, accuracy, model size, latency, compression time, and energy consumption.

A constraint on a device may include information for selecting the target device 350. The compressing system 300 may select the target device 350 from the target device pool 320 within the constraint on the device.

A constraint on accuracy may be a minimum threshold of accuracy required for a compressed inference model. In other words, the HPO 310 may compress the inference model so that the compressed inference model has accuracy of at least the minimum threshold in accordance with the constraint on accuracy. For example, the HPO 310 may select a set of parameters resulting in accuracy of at least the minimum threshold in accordance with the constraint on accuracy as the performance returned by the target device 350.

A constraint on model size may be a constraint on the size of a compressed model. When the constraint on model size is set, the HPO 310 may perform a performance test using compressed inference models having a size of the constraint on model size or less (or less than the constraint on model size) among compressed inference models.

A constraint on latency may be a constraint on a time that it takes for a compressed inference model to generate an output value for an input value. Latency of a compressed inference model may be included in the performance returned to the HPO 310 by the target device. The HPO 310 may select a set of parameters by selecting a compressed inference model which satisfies the constraint on latency on the basis of latency included in the returned performance.

A constraint on compression time may be a constraint on a time for generating a compressed inference model. For example, a time for generating an inference model satisfying a desired input condition is dependent on performance and resources of a system that compresses an inference model, and it may take a few days to compress one inference model. However, when a user sets the constraint on compression time, the HPO 310 may set a maximum number of learning times (epochs) or reduce the number of compression methods to be applied in sequence within the set constraint on compression time so that a generation time of a compressed inference model does not exceed the constraint on compression time set by the user.

A constraint on energy consumption may include a constraint on energy consumption of a target device in the case of measuring performance of a compressed inference model on the target device. In other words, the HPO 310 may select a set of parameters resulting in energy consumption of the target device that does not exceed the constraint on energy consumption set by the user. To this end, the target device may include an energy consumption measurement module, and energy consumption measured in the target device may be transmitted to the HPO 310 as a part of performance of the compressed inference model.

Meanwhile, a result (compressed inference model) satisfying all constraints may or may not be generated. As an example, in performance of a compressed inference model, it may be necessary to lower accuracy for shorter latency. As another example, it may be necessary to lower accuracy for lower energy consumption. Accordingly, the order of priority may be given to the constraints, and the HPO 310 may perform model optimization so that the constraints are satisfied in descending order of priority.

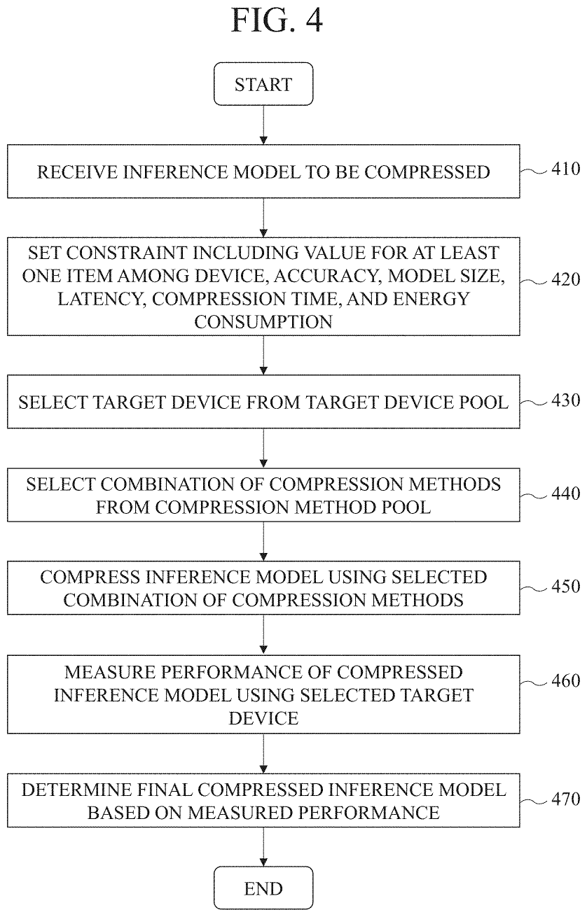

FIG. 4 is a flowchart illustrating an example of a compressing method according to an exemplary embodiment of the present disclosure. The compressing method according to the present exemplary embodiment may be performed by the computing device 200 that implements the HPO 310. As an example, the processor 220 of the computing device 200 may execute a control instruction in accordance with code of the operating system included in the memory 210 or code of at least one computer program. Here, the processor 220 may control the computing device 200 so that the computing device 200 performs operations 410 to 470 included in the method of FIG. 4 in accordance with the control instruction provided by the code stored in the computing device 200.

Referring to FIG. 4, in operation 410, an inference model to be compressed may be input to the computing device 200. The inference model may be a trained neural network model. According to an exemplary embodiment, a dataset and a constraint may be input together with the inference model. The dataset may include data and a label (a correct answer to the data) and may be provided to a target device and used for the target device to measure performance of a compressed inference model.

In operation 420, the computing device 200 may set a constraint including a value of at least one item among device, accuracy, model size, latency, compression time, and energy consumption. When a constraint on compression time is set, at least one of the number of training times of the compressed model on the target device and the number of compression methods included in a selected combination of compression methods may be adjusted in accordance with the set constraint on compression time. The set constraint may be a constraint that is input together with the inference model, but is not limited thereto. Also, according to an exemplary embodiment, the computing device 200 may further set the order of priority for items of the set constraint. The order of priority has been described above in detail.

In operation 430, the computing device 200 may select a target device from a target device pool. Here, the target device pool may correspond to the target device pool 320 described above with reference to FIG. 3. When a constraint on a device is set in operation 420, the computing device 200 may select a target device from the target device pool within the constraint on the device.

In operation 440, the computing device 200 may select a combination of compression methods from a compression method pool. Here, the compression method pool may correspond to the compression method pool 330 described above with reference to FIG. 3. The compression method pool may include two or more compression methods based on at least one of pruning, quantization, knowledge distillation, neural architecture search, resolution change, and filter decomposition. According to an exemplary embodiment, the computing device 200 may select a plurality of combinations of compression methods from the compression method pool.

Also, the computing device 200 may select a combination of compression methods in accordance with certain rules. For example, the computing device 200 may select a combination of compression methods in accordance with at least one of a first rule that a quantization-based compression method is to be positioned last in a combination of compression methods and a second rule that an activation change-based compression method is to be positioned before a quantization-based compression method. For example, quantization is frequently implemented in combination with a compiler. Accordingly, when quantization is used for compression at a software level, quantization may be positioned last in a compression pipeline. Also, activation change may be used to improve quantization performance, and thus an activation change-based compression method may be positioned before a quantization-based compression method in a combination of compression methods.

According to an exemplary embodiment, the order of performing operations 410 to 440 may be changed. For example, a target device may be selected after a combination of compression methods is selected, or a target device may be selected before an inference model is input.

In operation 450, the computing device 200 may compress the inference model using the selected combination of compression methods. For example, the computing device 200 may compress the inference model by sequentially applying methods included in the selected combination of compression methods to the inference model through the compression pipeline. The compression pipeline may correspond to the compression pipeline 340 described above with reference to FIG. 3. Meanwhile, when a plurality of combinations are selected in operation 440, the computing device 200 may compress the inference model using each of the selected plurality of combinations.

In operation 460, the computing device 200 may measure performance of the compressed inference model using the selected target device. For example, the computing device 200 may transmit the compressed inference model to the selected target device and receive a test result of the compressed inference model from the target device. The target device may be implemented to measure performance including at least one of latency and accuracy of the compressed inference model. When the inference model is compressed using each of a plurality of combinations, performance of a plurality of compressed inference models may be separately measured.

In operation 470, the computing device 200 may determine a final compressed inference model on the basis of the measured performance. As an example, the computing device 200 may determine the final compressed inference model on the basis of the measured performance and at least one of a constraint on accuracy, a constraint on latency, and a constraint on energy consumption. As another example, when a plurality of compressed inference models are generated by applying different set of parameters to the inference model or using a plurality of combinations of compression methods, the computing device 200 may determine a compressed inference model showing the highest performance as the final compressed inference model among the plurality of compressed inference models.

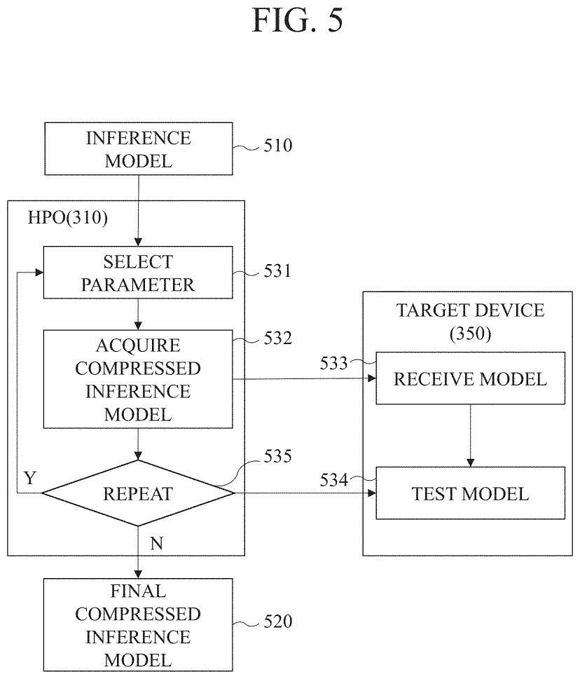

FIG. 5 is a diagram illustrating an example of an optimal parameter determination process according to an exemplary embodiment of the present disclosure. FIG. 5 shows the HPO 310 and the target device 350. The exemplary embodiment of FIG. 5 illustrates an example of a process in which the HPO 310 generates a final compressed inference model 520 by compressing an inference model 510 through the target device 350.

In a parameter selection process 531, the HPO 310 may select a parameter for the input inference model 510. As described above, the inference model 510 may be a model that is trained in advance, and the parameter may be a combination of parameters for a combination of multiple compression methods.

In a compressed inference model acquisition process 532, the HPO 310 may compress the inference model using the selected parameter. The compressed inference model may be generated when the compressor 360 compresses the inference model 510 using the selected parameter.

The compressed inference model may be transmitted to the target device 350. At this time, a dataset (including data and a label) input for the inference model 510 may be transmitted to the target device 350 together with the compressed inference model.

In a model reception process 533, the target device 350 may receive the compressed inference model from the HPO 310. As described above, the target device 350 may receive a dataset together with the compressed inference model.

In a model test process 534, the target device 350 may test the compressed inference model. As an example, the target device 350 may measure performance (e.g., latency, accuracy, etc.) of the compressed inference model by testing the compressed inference model using the data of the dataset and the label which is a correct answer and transmit the measured performance to the HPO 310. More specifically, the target device 350 may input the data of the dataset to the compressed inference model and measure latency on the basis of a time at which the data is input and a time at which the compressed inference model outputs a result of the input data. As another example, the target device 350 may compare the output result with the label which is a correct answer to the data to measure accuracy of the compressed inference model.

In a repetition process 535, the HPO 310 may determine whether to repeat the parameter selection process 531 to the model test process 534 in accordance with the performance received from the target device 350. For example, on the basis of the received performance, the HPO 310 may determine whether the compressed inference model satisfies all constraints or satisfies constraints up to a certain criterion in order of priority. When the constraints are satisfied, the HPO 310 may provide the compressed inference model as the final compressed inference model 520 without repeating the parameter selection process 531 to the model test process 534. On the other hand, when the constraints are not satisfied, the HPO 310 may repeat the parameter selection process 531 to the model test process 534 and test an inference model further compressed using a new parameter.

According to an exemplary embodiment, the repetition process 535 may be a process of testing a preset number of compressed inference models that are compressed simply using difference parameters. In this case, the HPO 310 may provide a compressed inference model showing the best performance within the constraints as the final compressed inference model 520.

According to another exemplary embodiment, the repetition process 535 may be a process of testing one compressed inference model on a preset number of different target devices.

Like this, according to exemplary embodiments of the present disclosure, a deep learning model can be compressed by applying various compressing techniques to the deep learning model in sequence and/or parallel.

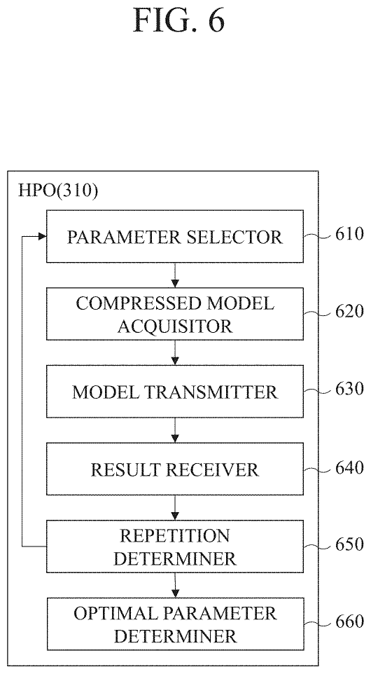

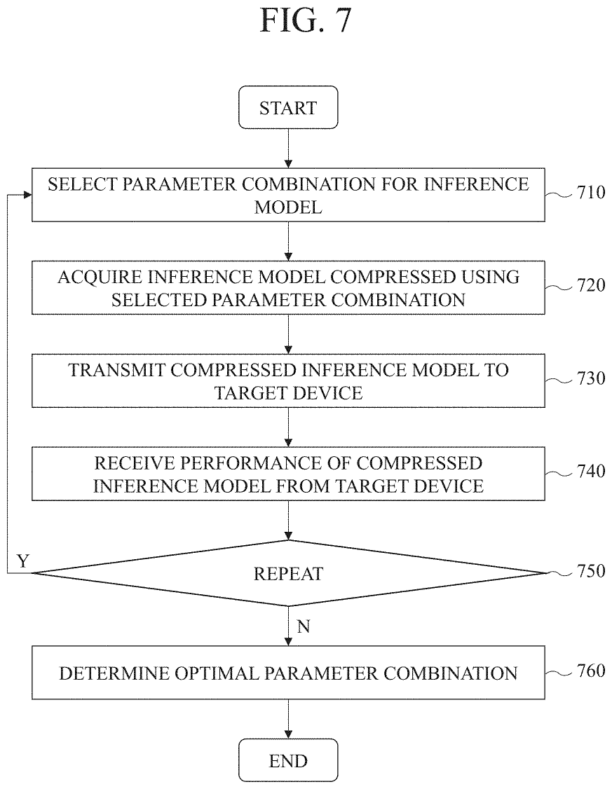

FIG. 6 is a block diagram illustrating an example of an internal configuration of HPO according to an exemplary embodiment of the present disclosure, and FIG. 7 is a flowchart illustrating an example of a method of determining an optimal parameter by HPO according to an exemplary embodiment of the present disclosure. The above-described HPO 310 may be implemented by the computing device 200.

Referring to FIG. 6, the HPO 310 of FIG. 6 may include a parameter selector 610, a compressed model acquisitor 620, a model transmitter 630, a result receiver 640, a repetition determiner 650, and an optimal parameter determiner 660. Here, the parameter selector 610, the compressed model acquisitor 620, the model transmitter 630, the result receiver 640, the repetition determiner 650, and the optimal parameter determiner 660 may be expressions of functions of the processor 220 of the computing device 200 which implements the HPO 310, operating in accordance with the control of a computer program. For example, the processor 220 of the computing device 200 may be implemented to execute a control instruction in accordance with the code of the operating system included in the memory 210 or code of at least one computer program. Here, the processor 220 may control the computing device 200 so that the computing device 200 performs operations 610 to 650 included in the method of FIG. 6 in accordance with the control instruction provided by the code stored in the computing device 200. In this case, the parameter selector 610, the compressed model acquisitor 620, the model transmitter 630, the result receiver 640, the repetition determiner 650, and the optimal parameter determiner 660 may be used as functions of the processor 220 for performing each of operations 610 to 650.

In operation 710, the parameter selector 610 may select a set of parameters for an inference model. For example, the parameter selector 610 may select at least one compression method as a combination of compression methods from the compression method pool 330 described above with reference to FIG. 3. Here, the compression method pool 330 may include two or more compression methods based on at least one of pruning, quantization, knowledge distillation, neural architecture search, resolution change, and filter decomposition.

In this case, the parameter selector 610 may select compression methods in accordance with certain rules. For example, the parameter selector 610 may select a combination of compression methods in accordance with at least one of a first rule that a quantization-based compression method is to be positioned last in a combination of compression methods and a second rule that an activation change-based compression method is to be positioned before a quantization-based compression method. For example, quantization is frequently implemented in combination with a compiler. Accordingly, when quantization is used for compression at a software level, quantization may be positioned last in a compression pipeline. Also, activation change may be used to improve quantization performance, and thus an activation change-based compression method may be positioned before a quantization-based compression method in a combination of compression methods.

Subsequently, the parameter selector 610 may select a combination of at least some of parameters of the at least one selected compression method as the combination of parameters. In other words, the set of parameters may include at least selected some parameters in accordance with the selected compression methods. As an example, a pruning-based compression method may include a PR as a parameter. In this case, the parameter selector 610 may select a parameter PR value from a set of values (e.g., select one value from a set of parameter PR values {0.3, 0.4, 0.5}) prepared in advance. Also, according to a filter decomposition-based compression method, a rank value may be selected from a set of values prepared in advance (e.g., one value may be selected from a parameter filter rank (FR) value set {2, 3, 4}). In other words, when the selected compression methods are a pruning-based first compression method and a filter decomposition-based second compression method, the parameter selector 610 may select [PR 0.4, FR 2] or [PR 0.3, FR 4] as parameter values for the selected compression methods.

To select a combination of parameter values, a technique such as Hyperband or Bayesian Optimization may be used. Such technique may be used later for selecting an optimal parameter set in accordance with multiple levels of performance.

As described above, multiple compressed inference models may be generated in parallel by applying different compression methods to one inference model in parallel. As an example, it has been described above that the HPO 310 may simultaneously generate multiple compressed models by running multiple compression pipelines. In this case, a performance value obtained from an inference model compressed through one compression pipeline may be used for selecting a set of parameters for another compression pipeline. As an example, it is assumed that the HPO 310 generates a first compressed inference model in compression pipeline A using combination a of compression methods and combination b of parameter values and then obtains a first performance value. Also, it is assumed that the HPO 310 generates a second compressed inference model in compression pipeline B which is run in parallel, using combination c of compression methods and combination d of parameter values and then obtains a performance value of 2. Then, in the case of selecting a combination of parameter values for combination a of compression methods in compression pipeline B, the HPO 310 may select combination e of new parameters for combination a of compression methods by considering combination b of parameter values and the first performance value. More specifically, when the first performance value is relatively high (e.g., when the first performance value is higher than a second performance value or a performance value resulting from another combination of compression methods), the HPO 310 may change only some parameter values in combination b of parameter values to select combination e of new parameter values. On the other hand, when the first performance value is relatively low (e.g., when the first performance value is lower than the second performance value or a performance value resulting from another combination of compression methods), the HPO 310 may change all the parameter values in combination b of parameter values to select combination e of new parameter values.

In operation 720, the compressed model acquisitor 620 may acquire a compressed inference model. The compressed inference model may be generated when the compressor 360 compresses the input inference model using the selected set of parameters. For example, the compressor 360 may compress the input inference model by sequentially applying the plurality of compression methods selected in operation 710. Here, the compressor 360 may compress the inference model using parameter values selected for the applied compression methods. In other words, the compressor 360 may generate the compressed inference model by sequentially applying the compression methods to which the selected parameter values are applied to the inference model. The compressor 360 may transmit the compressed inference model to the compressed model acquisitor 620.

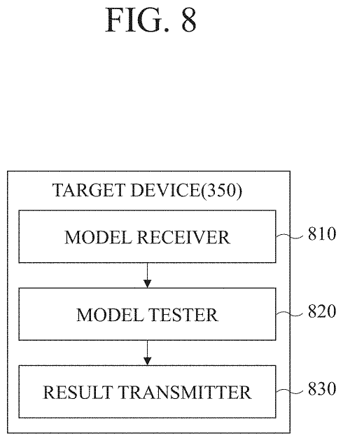

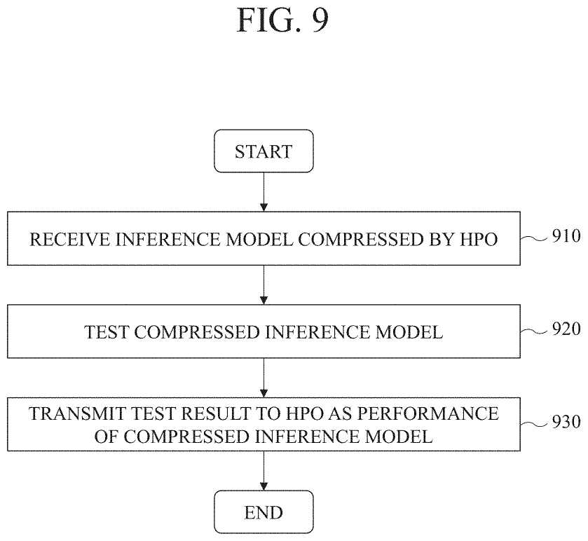

In operation 730, the model transmitter 630 may transmit the compressed inference model to a target device. Here, the target device may correspond to the target device 350 selected from the target device pool 320. The target device may measure performance of the compressed inference model as described below with reference to FIGS. 8 and 9 and transmit the performance to the HPO 310.

In operation 740, the result receiver 640 may receive the performance of the compressed inference model from the target device. For example, the received performance may include latency and accuracy that are measured when the target device inputs data to the compressed inference model.

In operation 750, the repetition determiner 650 may determine whether to repeat operations 710 to 740 on the basis of the received performance. Here, the repetition determiner 650 may determine whether to repeat operations 710 to 740 depending on whether the received performance satisfies a constraint input to (or set for) the inference model. For example, when the received performance satisfies the input (or set) constraint, the repetition determiner 650 may provide the parameter set used for compressing the inference model as an optimized parameter set for the target device without repeating operations 710 to 740. Also, the compressed inference model may be provided as a final compressed inference model for the target device. On the other hand, when received performance does not satisfy the input (or set) constraint, the repetition determiner 650 may repeat operations 710 to 740 to search for an optimal parameter set again. Here, in operation 710, the same combination of compression methods may be selected, or another combination of compression methods may be selected. When the same combination of compression methods is selected in operation 710, other values of parameters corresponding to the combination of compression methods may be selected in operation 720. On the other hand, when another combination of compression methods is selected in operation 710, values of other parameters corresponding to the other combination of compression methods may be selected in operation 720. In other words, when a combination of compression methods is changed, a combination of parameters may also be changed, and thus values of the changed parameters may be selected. When the combination of compression methods is maintained, the combination of parameters may also be maintained. In this case, only values of the parameters may be changed and selected.

Meanwhile, according to an exemplary embodiment, the repetition determiner 650 may repeat operations 710 to 740 a preset number of times. To this end, the repetition determiner 650 may compare the number of repetitions with the preset number of times and cause operations 710 to 740 to be repeated until the number of repetitions exceeds the preset number of times. In this case, every time operations 710 to 740 are repeated, a combination of compression methods and/or a combination of parameters may be changed. Accordingly, it is possible to measure performance of a compressed inference model for each combination of various compression methods and/or each combination of parameters.

In operation 760, the optimal parameter determiner 660 may determine an optimal parameter set in accordance with the received performance. For example, when a plurality of levels of performance are received from the target device as operations 710 to 740 are repeatedly performed, a set of parameters that results in the best performance may be determined as an optimal parameter set for the target device. As described above, a set of parameters may be a combination of parameter values in accordance with a combination of compression methods.

FIG. 8 is a block diagram illustrating an example of an internal configuration of a target device according to an exemplary embodiment of the present disclosure, and FIG. 9 is a flowchart illustrating an example of a method of determining an optimal parameter by a target device according to an exemplary embodiment of the present disclosure. The above-described target device 350 may also be implemented by the computing device 200.

Referring to FIG. 8, the target device 350 according to the present exemplary embodiment may include a model receiver 810, a model tester 820, and a result transmitter 830. The model receiver 810, the model tester 820, and the result transmitter 830 may be expressions of functions of the processor 220 of the computing device 200 which implements the target device 350, operating in accordance with the control of a computer program. For example, the processor 220 of the computing device 200 may be implemented to execute a control instruction in accordance with the code of the operating system included in the memory 210 or code of at least one computer program. Here, the processor 220 may control the computing device 200 so that the computing device 200 performs operations 810 to 830 included in the method of FIG. 8 in accordance with the control instruction provided by the code stored in the computing device 200. In this case, the model receiver 810, the model tester 820, and the result transmitter 830 may be used as functions of the processor 220 for performing each of operations 810 to 830.

In operation 910, the model receiver 810 may receive an inference model compressed by the HPO 310. Here, the model receiver 810 may receive an input dataset (data and a label) together with the inference model.

In operation 920, the model tester 820 may test the compressed inference model. Here, the model tester 820 may generate at least one of latency and accuracy as a test result of the compressed inference model. As an example, the model tester 820 may input the data of the dataset to the compressed inference model and measure latency on the basis of a time at which the data is input and a time at which the compressed inference model outputs a result of the input data. As another example, the model tester 820 may measure accuracy of the compressed inference model by comparing the output result and the label which is a correct answer to the data.

In operation 930, the result transmitter 930 may transmit the test result to the HPO 310 as performance of the compressed inference model. Here, the result receiver 640 of the HPO 310 may receive the performance of the inference model, and the HPO 310 may determine an optimal parameter set on the basis of the performance received from the target device.

As described above, according to exemplary embodiments of the present invention, it is possible to compress and provide an inference model to a target device and determine an optimal parameter set on the basis of performance of the compressed inference model provided by the target device.

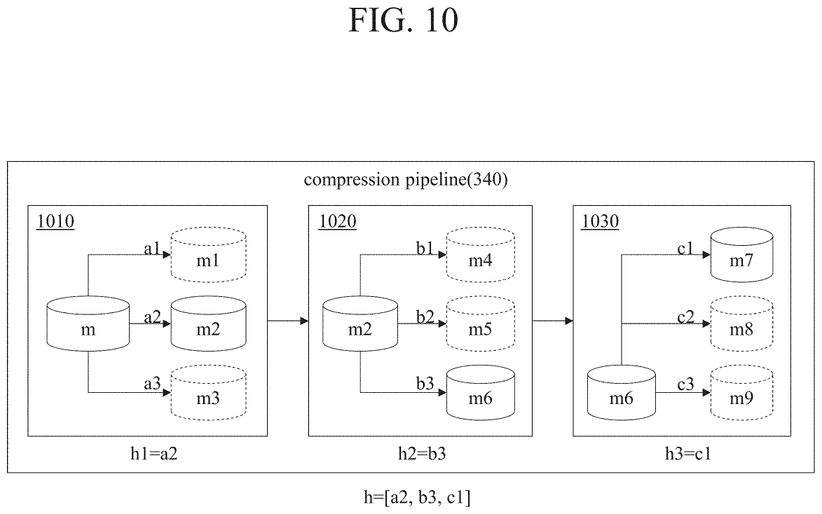

FIG. 10 is a diagram illustrating a method of determining an optimal parameter according to an exemplary embodiment of the present disclosure.

Referring to FIG. 10, in the compression pipeline 340, a first parameter h1, a second parameter h2, and a third parameter h3 constituting an optimal parameter set h may be sequentially disposed. Specifically, the first parameter h1 may be a parameter a2, the second parameter h2 may be a parameter b3, and the third parameter h3 may be a parameter c1. The compressor 360 may generate a final compressed model m7 by sequentially applying the first parameter h1, the second parameter h2, and the third parameter h3 to an inference model m input by the user. A method of determining the optimal parameter set h will be described below.

The HPO 310 may select first parameters a1, a2, and a3 to be applied to the inference model m. Each first parameter may include a compression method and a compression parameter corresponding to the compression method. For example, when the compression method is pruning, the compression parameter may be a PR representing how much pruning will be performed. The HPO 310 may arbitrarily select a compression method from the compression method pool and arbitrarily select a corresponding compression parameter.

The compressor 360 may apply the first parameters a1, a2, and a3 selected by the HPO 310 to the inference model m to generate first compressed models m1, m2, and m3, respectively. The HPO 310 may receive performance of the first compressed models m1, m2, and m3 from the target device 350. The HPO 310 may select the model m2 showing the highest performance among the first compressed models m1, m2, and m3. The HPO 310 may determine the first parameter a2 used for generating the model m2 as an optimal parameter corresponding to a first step of the compression pipeline 340.

The HPO 310 may determine whether to additionally compress the model m2. In the case of additionally compressing the model m2, the HPO 310 may select second parameters b1, b2, and b3 to be applied to the model m2. Each second parameter may include a compression method and a compression parameter corresponding to the compression method.

The compressor 360 may apply the second parameters b1, b2, and b3 selected by the HPO 310 to the model m2 to generate second compressed models m4, m5, and m6, respectively. The HPO 310 may receive performance of the second compressed models m4, m5, and m6 from the target device 350. The HPO 310 may select the model m6 showing the highest performance among the second compressed models m4, m5, and m6. The HPO 310 may determine the second parameter b3 used for generating the model m6 as an optimal parameter corresponding to a second step of the compression pipeline 340.

The HPO 310 may determine whether to additionally compress the model m6. In the case of additionally compressing the model m6, the HPO 310 may select third parameters c1, c2, and c3 to be applied to the model m6. Each third parameter may include a compression method and a compression parameter corresponding to the compression method.

The compressor 360 may apply the third parameters c1, c2, and c3 selected by the HPO 310 to the model m6 to generate third compressed models m7, m8, and m9, respectively. The HPO 310 may receive performance of the third compressed models m7, m8, and m9 from the target device 350. The HPO 310 may select the model m7 showing the highest performance among the third compressed models m7, m8, and m9. The HPO 310 may determine the third parameter c1 used for generating the model m7 as an optimal parameter corresponding to a third step of the compression pipeline 340.

The HPO 310 may determine whether to additionally compress the model m7. In the case of not additionally compressing the model m7, the HPO 310 may determine a combination of the step-specific parameters used for generating the model m7 as an optimal parameter set. In other words, the HPO 310 may determine a combination of the parameters a2, b3, and c1 as the optimal parameter set h.

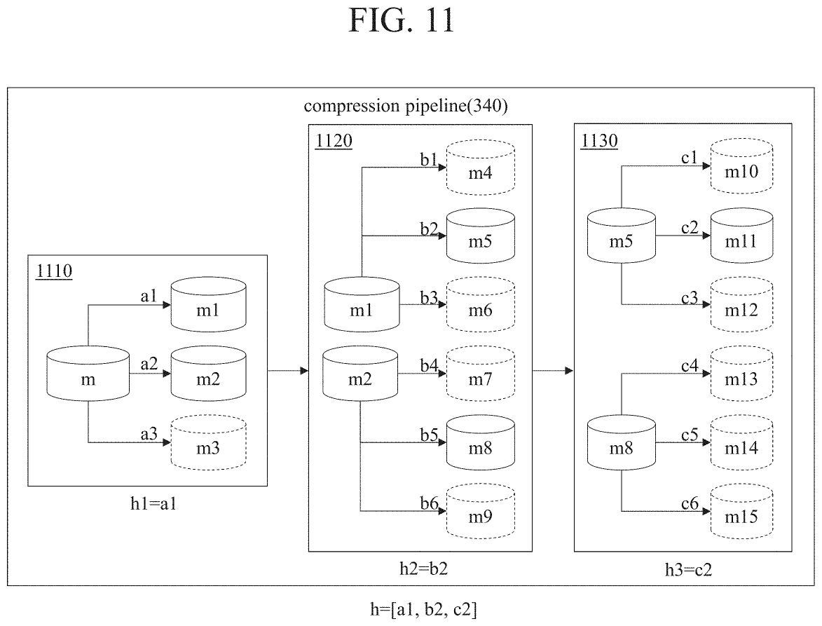

FIG. 11 is a diagram illustrating a method of determining an optimal parameter according to another exemplary embodiment of the present disclosure.

Referring to FIG. 11, in the compression pipeline 340, a first parameter h1, a second parameter h2, and a third parameter h3 constituting an optimal parameter set h may be sequentially disposed. Specifically, the first parameter h1 may be a parameter a1, the second parameter h2 may be a parameter b2, and the third parameter h3 may be a parameter c2. The compressor 360 may generate a final compressed model m7 by sequentially applying the first parameter h1, the second parameter h2, and the third parameter h3 to an inference model m input by the user. A method of determining the optimal parameter set h will be described below.

The HPO 310 may select first parameters a1, a2, and a3 to be applied to the inference model m. Each first parameter may include a compression method and a compression parameter corresponding to the compression method.

The compressor 360 may apply the first parameters a1, a2, and a3 selected by the HPO 310 to the inference model m to generate first compressed models m1, m2, and m3, respectively. The HPO 310 may receive performance of the first compressed models m1, m2, and m3 from the target device 350. The HPO 310 may select at least one of the first compressed models m1, m2, and m3 on the basis of a constraint input by the user. For example, the HPO 310 may select the models m1 and m2 that satisfy the constraint. Also, the HPO 310 may determine the first parameters a1 and a2 used for generating the selected models m1 and m2 as first candidate parameters.

Meanwhile, the HPO 310 may select a predetermined number of models from among the first compressed models m1, m2, and m3 in descending order of performance. For example, when the predetermined number is 2, the HPO 310 may select the model m1 showing the highest performance and the model m2 showing the second highest performance. Also, the HPO 310 may select models satisfying the constraint input by the user from among the first compressed models and then select the predetermined number of models from among the selected models in descending order of performance.

The HPO 310 may determine whether to additionally compress the models m1 and m2. In the case of additionally compressing the models m1 and m2, the HPO 310 may select second parameters b1, b2, b3, b4, b5, and b6 to be applied to the models m1 and m2. Each second parameter may include a compression method and a compression parameter corresponding to the compression method.

The compressor 360 may generate second compressed models m4, m5, m6, m7, m8, and m9 by applying the second parameters b1, b2, b3, b4, b5, and b6 selected by the HPO 310 to the models m1 and m2. The HPO 310 may receive performance of the second compressed models m4, m5, m6, m7, m8, and m9 from the target device 350. The HPO 310 may identify a model satisfying the constraint from among the second compressed models m4, m5, m6, m7, m8, and m9. For example, the HPO 310 may select the models m5 and m8. Also, the HPO 310 may determine the second parameters b2 and b5 used for generating the selected models m5 and m8 as second candidate parameters.

The HPO 310 may determine whether to additionally compress the models m5 and m8. In the case of additionally compressing the models m5 and m8, the HPO 310 may select third parameters c1, c2, c3, c4, c5, and c6 to be applied to the models m5 and m8. Each third parameter may include a compression method and a compression parameter corresponding to the compression method.

The compressor 360 may generate third compressed models m10, m11, m12, m13, m14, and m15 by applying the third parameters c1, c2, c3, c4, c5, and c6 selected by the HPO 310 to the models m5 and m8. The HPO 310 may receive performance of the third compressed models m10, m11, m12, m13, m14, and m15 from the target device 350. The HPO 310 may identify a model satisfying the constraint from among the third compressed models m10, m 11, m12, m13, m14, and m15. For example, the HPO 310 may select the model m11. Also, the HPO 310 may determine the third parameter c2 used for generating the selected model m11 as a third candidate parameter.

The HPO 310 may determine whether to additionally compress the model m11. In the case of not additionally compressing the model m11, the HPO 310 may determine a combination of the step-specific parameters used for generating the model m11 as an optimal parameter set. In other words, the HPO 310 may determine a combination of the parameters a1, b2, and c2 as the optimal parameter set h.

Although FIGS. 10 and 11 illustrate a case in which three steps are included in the compression pipeline 340, this is merely an embodiment, and the number of steps included in the compression pipeline 340 is not necessarily limited to 3.

Also, the types of compression methods corresponding to parameters included in one step of the compression pipeline 340 may differ from each other. For example, a compression method corresponding to the parameter a1 may be pruning, and a compression method corresponding to the parameter a2 may be filter decomposition.

The above-described systems or devices may be implemented using hardware components or a combination of hardware components and software components. For example, the devices and components described in the exemplary embodiments may be implemented using one or more general-purpose or special purpose computers, such as a processor, a controller, an arithmetic logic unit (ALU), a digital signal processor, a microcomputer, a field programmable gate array (FPGA), a programmable logic unit (PLU), a microprocessor, or any other device that may execute and respond to instructions. A processing device may run an operating system and one or more software applications that are executed on the operating system. The processing device may also access, store, manipulate, process, and create data in response to execution of the software. For convenience of understanding, it has been described that one processing device is used in some cases, but those of ordinary skill in the art will appreciate that a processing device may include a plurality of processing elements and/or a plurality of types of processing elements. For example, the processing device may include a plurality of processors or one processor and one controller. In addition, different processing configurations are possible such as parallel processors.

The software may include a computer program, code, an instruction, or one or more combinations thereof and configure the processing device to operate as desired or independently or collectively instruct the processing device. The software and data may be embodied in any type of machine, component, physical equipment, virtual equipment, or computer storage medium or device to be interpreted by the processing device or to provide instructions or data to the processing device. The software may also be distributed over computer systems connected through a network so that the software is stored and executed in a distributed manner. The software and data may be stored in one or more computer-readable recording media.

A method according to an exemplary embodiment may be implemented in the form of program instructions that may be executed by various computing devices, and recorded in a computer-readable medium. The computer-readable medium may include program instructions, data files, data structures, etc. solely or in combination. The medium may continuously store computer-executable programs or temporarily store the same for execution or downloading. Also, the medium may be one of various recording devices or storage devices in a form in which one or more hardware components are combined. The medium may be distributed over the network without being limited to a medium directly connected to a computer system. Examples of the medium include magnetic media, such as a hard disk, a floppy disk, and a magnetic tape, optical media, such as a CD-ROM and a DVD, magneto-optical media, such as a floptical disk, and media configured to store program instructions such as a ROM, a RAM, a flash memory, etc. Examples of other media may include a recording medium and a storage medium managed by the App Store that distributes applications or other websites, servers, etc. that supply various types of software. Examples of program instructions include both machine code, such as that produced by a compiler, and high-level language code that may be executed by a computer using an interpreter and the like.

According to an exemplary embodiment of the present disclosure, a deep learning model can be compressed by applying various compressing techniques to a deep learning model in sequence and/or parallel.

According to an exemplary embodiment of the present disclosure, when a user simply inputs a deep learning model, a dataset, and a constraint, a computing device can provide an optimal parameter set for compressing the deep learning model. Accordingly, convenience of the user can be improved.

Although the present disclosure has been described with reference to the limited exemplary embodiments and drawings, it will be apparent to those of ordinary skill in the art that various modifications and alterations can be made from the above description. For example, suitable results may be achieved even when the described techniques are performed in a different order and/or even when components of a described system, architecture, device, circuit, etc. are combined in a form different from a described method or replaced by or substituted with other components or equivalents.

Therefore, other implementations, other embodiments, and equivalents to the claims also fall into the scope of the following claims.

What is claimed is:

1. A method of determining an optimal parameter set that is performed by a computing device including at least one processor, the method comprising:
receiving an inference model, a dataset, and a constraint;
configuring a set of compression methods to be applied to the inference model and a set of parameters for the set of compression methods on the basis of the constraint;
applying a first compression method included in the set of compression methods and a first parameter related to the first compression method to the inference model, through a compression pipeline;
determining whether a compressed inference model is generated from the inference model through the compression pipeline;
when it is determined that the compressed inference model is not generated, applying a second compression method included in the set of compression methods, and a second parameter among the set of parameters to the inference model, following the first compression method, through the compression pipeline;
when it is determined that the compressed inference model is generated, transmitting the compressed inference model to the target device; and
determining an optimal set of parameters on the basis of the performance of the compressed inference model received from the target device,
wherein the performance of the compressed inference model is measured by the target device using the dataset.

2. The method of claim 1, wherein the configuring the set of compression methods and the set of parameters includes:
selecting the first compression method and the first parameter for the first compression method;
determining whether to further select a compression method and a parameter on the basis of the constraint and the first compression method; and
when it is determined to further select a compression method and a parameter, selecting the second compression method and the second parameter for the second compression method on the basis of the first compression method.

3. The method of claim 1, wherein when the performance of the compressed inference model satisfies the constraint, the selected set of parameters is determined as the optimal parameter set, and
wherein when the performance of the compressed inference model does not satisfy the constraint, the configuring the set of compression methods and the set of parameters, the applying the first compression method and the first parameter to the inference model, the determining whether the compressed inference model is generated, the applying the second compression method and the second parameter to the inference model, the transmitting the compressed inference model to the target device, and the determining the optimal parameter set are repeatedly performed.

4. The method of claim 1, wherein the constraint includes a value of at least one item among device, accuracy, model size, latency, compression time, and energy consumption.

5. The method of claim 1, wherein a priority is assigned to each of a plurality of items included in the constraint, and
wherein the determining the optimal set of parameters includes:
determining whether the compressed inference model satisfies the constraint based on the priority at least a predetermined criterion on the basis of the performance of the compressed inference model.

6. The method of claim 1, wherein the set of compression methods are selected from a compression method pool, and
wherein the compression method pool includes pruning, quantization, resolution change, and filter decomposition.

7. The method of claim 1, wherein the performance of the compressed inference model includes a value of at least one item among latency, accuracy, and energy consumption.

8. The method of claim 1, wherein the set of compression methods is configured on the basis of a predetermined rule, and
the predetermined rule includes at least one of a first rule that a quantization-based compression method included in the optimal parameter set is to be positioned last in the compression pipeline or a second rule that an activation change-based compression method is to be positioned before the quantization-based compression method.

9. A computing device for determining an optimal parameter set, the computing device comprising:
a memory configured to store at least one instruction; and
at least one processor executing the at least one instruction, wherein the processor is configured to:
receive an inference model, a dataset, and a constraint,
configure a set of compression methods to be applied to the inference model and a set of parameters for the set of compression methods on the basis of the constraint,
apply a first compression method included in the set of compression methods and a first parameter related to the first compression method to the inference model, through a compression pipeline,
determine whether a compressed inference model is generated from the inference model through the compression pipeline,
when it is determined that the compressed inference model is not generated, apply a second compression method included in the set of compression methods, and a second parameter among the set of parameters to the inference model, following the first compression method, through the compression pipeline,
when it is determined that the compressed inference model is generated, transmit the compressed inference model to the target device, and
determine an optimal set of parameters on the basis of the performance of the compressed inference model received from the target device,
wherein the performance of the compressed inference model is measured by the target device using the dataset.

10. The computing device of claim 9, wherein the processor is further configured to:
select the first compression method and the first parameter for the first compression method,
determine whether to further select a compression method and a parameter on the basis of the constraint and the first compression method, and
when it is determined to further select a compression method and a parameter, select the second compression method and the second parameter for the second compression method on the basis of the first compression method.

11. The computing device of claim 9, wherein when the performance of the compressed inference model satisfies the constraint, the selected set of parameters is determined as the optimal parameter set, and
wherein when the performance of the compressed inference model does not satisfy the constraint, the processor is further configured to: repeatedly configure the set of compression methods and the set of parameters, apply the first compression method and the first parameter to the inference model, determine whether the compressed inference model is generated, apply the second compression method and the second parameter to the inference model, transmit the compressed inference model to the target device, and determine the optimal parameter set.

12. The computing device of claim 9, wherein the constraint includes a value of at least one item among device, accuracy, model size, latency, compression time, and energy consumption.

13. The computing device of claim 9, wherein a priority is assigned to each of a plurality of items included in the constraint, and
wherein the processor is further configured to determine whether the compressed inference model satisfies the constraint based on the priority at least a predetermined criterion on the basis of the performance of the compressed inference model.

14. The computing device of claim 9, wherein the processor is further configured to select the set of compression methods from a compression method pool, and
wherein the compression method pool includes pruning, quantization, resolution change, and filter decomposition.

15. The computing device of claim 9, wherein the performance of the compressed inference model includes a value of at least one item among latency, accuracy, and energy consumption.

16. The computing device of claim 9, wherein the processor is further configured to configure the set of compression methods on the basis of a predetermined rule, and
the predetermined rule includes at least one of a first rule that a quantization-based compression method included in the optimal parameter set is to be positioned last in the compression pipeline or a second rule that an activation change-based compression method is to be positioned before the quantization-based compression method.
